(19) United States
(12) Patent Application Publication
(10) Pub. No.: US 2026/0254221 A1
(43) Pub. Date: Aug. 27, 2026

(54) AC SHORT-CIRCUIT ICE-MELTING CONTROL METHOD AND ICE-MELTING DISTRIBUTION TRANSFORMER

(71) Applicant: Guizhou Power Grid Co., Ltd., Guiyang (CN)

(72) Inventors: Yue LI, Guiyang (CN); Hao YANG, Guiyang (CN); Anjiang LIU, Guiyang (CN); Youzhuo ZHENG, Guiyang (CN); Shuqing HAO, Guiyang (CN); Yutao XU, Guiyang (CN); Chen DOU, Guiyang (CN); Yongxiang CAI, Guiyang (CN); Yu MIAO, Guiyang (CN); Xiaobing XIAO, Guiyang (CN); Wei HUANG, Guiyang (CN); Hengrong ZHANG, Guiyang (CN); Haiya ZHENG, Guiyang (CN); Di WENG, Guiyang (CN); Song ZHANG, Guiyang (CN); Mengqi LI, Guiyang (CN); Xiaomeng HE, Guiyang (CN); Guiyu WU, Guiyang (CN); Di YANG, Guiyang (CN)

(21) Appl. No.: 19/334,163

(22) Filed: Sep. 19, 2025

(30) Foreign Application Priority Data
Feb. 24, 2025 (CN) 202510201489.7

(51) Int. Cl. H02G 7/16; H01F 27/40; H05B 3/00

(52) U.S. Cl. CPC H02G 7/16; H01F 27/402; H05B 3/0023; H01F 2027/406; H05B 2214/02

(57) ABSTRACT

The present application relates to the technical field of power grid ice-melting, in particular to an AC short-circuit ice-melting control method and an ice-melting distribution transformer. The present application includes a distribution transformer with dual functions of voltage reduction and ice-melting, an ice-melting control system and its control method. The transformer is equipped with two groups of low-voltage output terminals, which are respectively used for power distribution supply and ice-melting operations; the ice-melting control system includes a local intelligent control box and a remote communication control box, and uses a deep reinforcement learning model to calculate the optimal ice-melting power gear and ice-melting time.

### CROSS-REFERENCE TO RELATED APPLICATIONS

This application claims priority to a Chinese Application No. 202510201489.7, filed on Feb. 24, 2025, titled “AC Short-Circuit Ice-Melting Control Method and Ice-Melting Distribution Transformer”, the entire contents of which are hereby incorporated herein by reference in their entirety.

### TECHNICAL FIELD

The present application relates to the technical field of power grid deicing, in particular to an alternative current (AC) short-circuit ice-melting control method and an ice-melting distribution transformer.

### BACKGROUND

The icing phenomenon on distribution network lines poses a significant challenge to the stable operation of power systems, especially under severe weather conditions. Currently, ice prevention and removal measures for distribution network lines mainly rely on traditional manual observation and manual ice knocking operations. Although this method can alleviate the threat caused by icing to a certain extent, its inherent limitations are obvious. In cold regions or extreme weather conditions, the ice layer formed on the surface of power lines not only increases the line load but also may lead to serious accidents such as wire breakage and pole collapse, threatening the safe and stable operation of the power grid.

At present, the deicing methods for distribution network lines mainly include manual ice knocking, thermal ice melting, and mechanical deicing. Although the manual ice knocking method is intuitive and simple, it has problems such as low efficiency in manual ice observation and knocking, difficulty in fully covering the extensive distribution network line network, low operation efficiency, high safety risks, and limited coverage. Especially under severe weather conditions, a large amount of human input not only increases the operation and maintenance costs but also makes it difficult to ensure timely handling of potential icing hazards across the entire network. Since distribution network lines often span vast areas and have a complex distribution, realizing real-time monitoring and rapid response to the icing situation of each line requires a large amount of human resources and time costs. This not only increases the difficulty of operation and maintenance work but also limits the possibility of timely and effective handling of icing problems.

To address this challenge, the industry has carried out a series of research and development work on ice-melting technologies, such as the “A Distribution Network Line Ice-Melting Method and System Based on Distribution Transformers in Station Areas” disclosed in Patent Application No. CN119093258A. However, these solutions still face many problems in practical applications: first, the existing ice-melting systems have cumbersome operating procedures, requiring manual switching of line switches one by one, which is not only inefficient but also increases operational risks; second, due to the lack of special transformation of distribution transformers, the ice-melting distance is limited, and the dual functions of power distribution and ice melting cannot be realized; third, the lack of intelligent communication protocols and control algorithms leads to insufficient system reliability and adaptability.

In addition, the existing ice-melting control systems generally have problems such as weak data collection and analysis capabilities, lack of remote monitoring functions, and low efficiency of fault diagnosis. Under complex climatic conditions, these technical limitations seriously affect the effect of ice-melting operations and the reliability of power grid operation.

### SUMMARY

In view of the problems existing in the related art, the present application is proposed. Therefore, the problem to be solved by the present application is how to address the common issues of existing ice-melting control systems, such as weak data collection and analysis capabilities, lack of remote monitoring functions, and low efficiency of fault diagnosis.

To solve the above technical problems, the present application provides the following technical solutions:

In a first aspect, the embodiments of the present application provides an alternative current (AC) short-circuit ice-melting control method, comprising:
obtaining environmental parameters and equipment parameters of an ice-melting line, where the environmental parameters comprise temperature, humidity, a wind speed, and an ice thickness, and the equipment parameters comprise a rated capacity and a power factor of an ice-melting transformer, and a number of temperature sensors;
based on the environmental parameters and the equipment parameters, using a deep reinforcement learning model to calculate an optimal ice-melting power gear and ice-melting time;
wherein the deep reinforcement learning model comprises:
an actor network, configured to select an ice-melting power gear according to a state, where the actor network comprises an input layer with the same dimension as the state, two hidden layers with 256 nodes, and an output layer corresponding to three ice-melting power gears;
a critic network, configured to evaluate a rationality of a selected power gear, where the critic network comprises an input layer for state and action information, two hidden layers with 256 nodes, and an output layer representing Q value;
wherein the deep reinforcement learning model further comprises: an exploration strategy based on visibility, where an exploration probability F satisfies:

$$ε = 0.1 + 0.5 \times ( \frac{1 - visibility}{100} ) ;$$

wherein visibility is a current visibility with an unit in hectometers;
based on the optimal ice-melting power gear and the ice-melting time, controlling an output voltage and a switch sequence of the ice-melting transformer, where the switch sequence comprises action sequences of a boundary switch, an ice-melting switch, a protection switch, and a short-circuit switch;
calculating a temperature rise sensitivity coefficient, which is obtained based on a division of load rate scenarios and a calculation of temperature fluctuation of the ice-melting transformer in seven operating days;
wherein operation data of the ice-melting transformer in seven operating days is divided into six load rate scenarios according to [0.20%], (20%,40%], (40%,60%], (60%,80%], (80%,100%], and 100%, and the temperature rise sensitivity coefficient under each scenario is calculated based on a relationship between a power fluctuation value and a temperature fluctuation value;
based on the temperature rise sensitivity coefficient, real-time monitoring a current value during an ice-melting process;
when the current value reaches a preset ice-melting current demand value, maintaining a current voltage gear; and
when the current value does not reach the preset ice-melting current demand value, adjusting the current voltage gear until a requirement is met.

In one embodiment, using the deep reinforcement learning model for adaptive control of ice-melting power includes:
discretizing the ice-melting power into three actions: fast, medium, and slow;
predicting a change of the ice thickness according to environmental parameters;
calculating a line ice load and a risk of pole collapse;
controlling the ice-melting power based on a balance of risk and cost;
where the balance of risk and cost uses a reward function for ice-melting power control, and the reward function for the balance of risk and cost needs to adopt a coefficient value of ice-melting cost;
wherein a prediction of the ice thickness change uses a following formula:

$${D}_{new} = d + {k}_{1} \times ( {T}_{ref} - T ) \times \frac{( RH - {RH}_{ref} )}{100} \times v \times t ;$$

wherein, D_{new} is a predicted new ice thickness; d is a current ice thickness; k1 is an ice thickness coefficient; T_{ref} is a reference temperature; RH is an ambient temperature; T is an ambient relative humidity; RH_{ref} is a reference humidity; v is a wind speed; t is the time;
wherein the line ice load is calculated using a following formula:

$$F = 9.82 \times {10}^{- 8} \times ρ \times π \times [ {( D + 2 {D}_{new} )}^{2} - {D}^{2} ] \times L ;$$

wherein, ρ is a density of ice; D is a diameter of a transmission line; D_{new} is the ice thickness; L is a length of the transmission line between adjacent towers;
wherein a risk P of pole collapse is calculated using a following formula:

$$P = \frac{F}{{F}_{m}} ;$$

wherein F is an ice load; Fₘ is a rated ice load;
wherein the ice-melting cost C is calculated using a following formula:

$$C = {f}_{( pow )} \times {D}_{new} ;$$

wherein C is the ice-melting cost, f_{(pow)} is a function of a relationship between power and cost, and D_{new} is the ice thickness;
wherein the reward function R_{reward} for the balance of risk and cost uses a following formula:

$${R}_{reward} = – {λ}_{1} \times P - {λ}_{2} \times C ;$$

wherein R_{reward} is used to balance an impact of risk and cost, λ₁ and λ₂ are weight coefficients, P is the risk of pole collapse, and C is the ice-melting cost.

In one embodiment, a control of the switch sequence includes:
before a start of ice-melting operation, isolating non-ice-melting areas through the boundary switch;
based on a preset program, controlling a start and adjustment of ice-melting current through the ice-melting switch;
real-time monitoring a line status through the protection switch, and cutting off a power supply when an abnormality is detected; and
controlling a short-circuit of an end line through the short-circuit switch to form an ice-melting loop.

In one embodiment, the alternative current (AC) short-circuit ice-melting control method further includes:
calculating and monitoring an ice-melting efficiency, wherein the ice-melting efficiency is a ratio of an actual ice-melting power to a maximum ice-melting power;
when the ice-melting efficiency is lower than a preset threshold, adjusting the optimal ice-melting power gear.

In one embodiment, the alternative current (AC) short-circuit ice-melting control method further includes: a remote control:
establishing a communication link between a local intelligent control box and a remote short-circuit communication control box; and
realize remote monitoring, fault diagnosis, and emergency response.

In one embodiment, during the ice-melting process, when the ambient temperature is higher than a preset temperature threshold or the ice thickness is less than the preset thickness threshold, automatically stopping the ice-melting process, and recording the ice-melting time and power data.

In a second embodiment, embodiments of the present application provides an ice-melting distribution transformer, comprising:
a transformer body, configured with two groups of low-voltage output terminals, wherein a first group is a normal voltage output terminal designed for power distribution users, and a second group is a specific voltage output terminal designed for ice-melting operations;
wherein the two groups of low-voltage output terminals have two states: one is working alone, and another is carrying out ice-melting and supplying power to low-voltage users at the same time;
wherein output voltages of the two groups of low-voltage output terminals satisfy:

$${V}_{out} = \frac{{N}_{out}}{{N}_{in}} \times {V}_{in} ;$$

wherein Vₒᵤₜ is an voltage of the low-voltage output terminal; Nₒᵤₜ is a number of turns of a coil of the low-voltage output terminal; Nᵢₙ is a number of turns of a coil of an input terminal; Vᵢₙ is a voltage of the input terminal;
wherein an ice-melting power of the specific voltage output terminal designed for ice-melting operations satisfies:

$${P}_{ice - melting} = {V}_{ice - melting} \times {I}_{ice - melting} ;$$

wherein P_{ice-melting} is the ice-melting power of the specific voltage output terminal; V_{ice-melting} is a voltage of the specific voltage output terminal used for ice-melting; I_{ice-melting} is a current during ice-melting;
an ice-melting control box, comprising a local intelligent control box and a remote short-circuit communication control box, where the local intelligent control box is provided with a one-key ice-melting button;
an ice-melting power regulating device, provided with multiple gears of ice-melting power output at an ice-melting output terminal;
wherein an efficiency of the ice-melting power output satisfies:

$${η}_{ice - melting} = \frac{{P}_{actual ice - melting}}{{P}_{maximum ice - melting}} ;$$

wherein η_{ice-melting} is an ice-melting efficiency; P_{actual ice-melting} is an actually used ice-melting power; P_{maximum ice-melting} is an ice-melting power of the transformer at a highest gear; and
a switch control system, comprising the boundary switch, the ice-melting switch, the protection switch, and the short-circuit switch.

In one embodiment, the second group of specific voltage output terminals has multiple optimal ice-melting power gears for adjusting the output voltage according to an actual ice-covered distance and conductor types.

In one embodiment, a deep reinforcement learning model operation unit is provided inside the local intelligent control box for calculating the multiple optimal ice-melting power gears and ice-melting time.

In one embodiment, the remote short-circuit communication control box is connected to the local intelligent control box through a high-speed communication link to realize remote synchronous control.

The beneficial effects of the present application are as follows: the present application provides an AC short-circuit ice-melting control method and an ice-melting distribution transformer. By adopting the structural design of dual output terminals of the distribution transformer, the perfect combination of power supply and ice-melting functions is realized, thereby solving the problem that traditional schemes require a special ice-melting transformer or temporary modification, and achieving the effect of dual use of one machine and saving investment.

By introducing an ice-melting control strategy based on deep reinforcement learning, the system can independently learn the optimal ice-melting power gear and ice-melting time, thereby overcoming the defect that traditional fixed strategies cannot adapt to complex climatic conditions, and realizing the intelligent and precise control of the ice-melting process, and significantly improving the ice-melting efficiency.

By designing a multi-level optimal ice-melting power gear adjustment mechanism and combining with real-time calculation of the temperature rise sensitivity coefficient, the system can flexibly adjust the power output according to the actual icing situation, thereby avoiding the problems of energy waste or insufficient ice-melting caused by rough power adjustment in traditional schemes, and achieving the effects of refined control, energy conservation and environmental protection.

By integrating the coordinated control strategy of the boundary switch, ice-melting switch, protection switch and short-circuit switch, the system realizes the fully automatic operation of the ice-melting process, thereby eliminating the potential safety hazards caused by traditional manual operations, significantly improving the operation efficiency, and achieving safe, reliable, efficient and convenient ice-melting operations.

By establishing a two-way real-time communication mechanism between the local intelligent control box and the remote communication control box, the system is equipped with remote monitoring, fault diagnosis and emergency handling capabilities, thereby overcoming the problem of insufficient remote management capabilities in traditional schemes, realizing intelligent operation and maintenance and rapid response.

By designing a mechanism for real-time monitoring and automatic adjustment of ice-melting efficiency, the system can dynamically optimize ice-melting parameters, ensuring ice-melting quality while avoiding energy waste, and realizing the unity of economy and efficiency in the ice-melting process.

The one-key ice-melting function is realized, which simplifies the operation process and improves the ice-melting efficiency. The ice-melting time only takes 1 hour, meeting a wider range of ice-melting needs. Compared with the traditional manual knocking method, the efficiency is greatly improved and the safety risk is reduced.

### BRIEF DESCRIPTION OF THE DRAWINGS

To clearly illustrate the technical solutions of the embodiments of the present application, the accompanying drawings required for describing the embodiments will be briefly introduced below. Obviously, the drawings in the following description are only some embodiments of the present application. For those skilled in the art, other drawings can also be obtained based on these drawings without creative work.

FIG. 1 is a flowchart of an AC short-circuit ice-melting control method and the ice-melting distribution transformer.

FIG. 2 is a diagram of computer equipment for the AC short-circuit ice-melting control method and the ice-melting distribution transformer.

FIG. 3 is a schematic diagram of the AC short-circuit ice-melting control method and the ice-melting distribution transformer.

FIG. 4 is a schematic diagram of a local controller of the AC short-circuit ice-melting control method and the ice-melting distribution transformer.

FIG. 5 is a schematic diagram of a remote controller of the AC short-circuit ice-melting control method and the ice-melting distribution transformer.

### DETAILED DESCRIPTION OF THE EMBODIMENTS

To make the above objectives, features, and advantages of the present application more comprehensible, the specific implementations of the present application will be described in detail below with reference to the accompanying drawings in the specification.

In the following description, numerous specific details are set forth to facilitate a full understanding of the present application. However, the present application can also be implemented in other ways different from those described herein, and those skilled in the art can make similar promotions without departing from the connotation of the present application. Therefore, the present application is not limited by the specific embodiments disclosed below.

Secondly, the “one embodiment” or “an embodiment” referred to herein refers to a specific feature, structure, or characteristic that can be included in at least one implementation of the present application. The occurrences of “in one embodiment” in different places in this specification do not all refer to the same embodiment, nor are they separate or alternatively mutually exclusive embodiments.

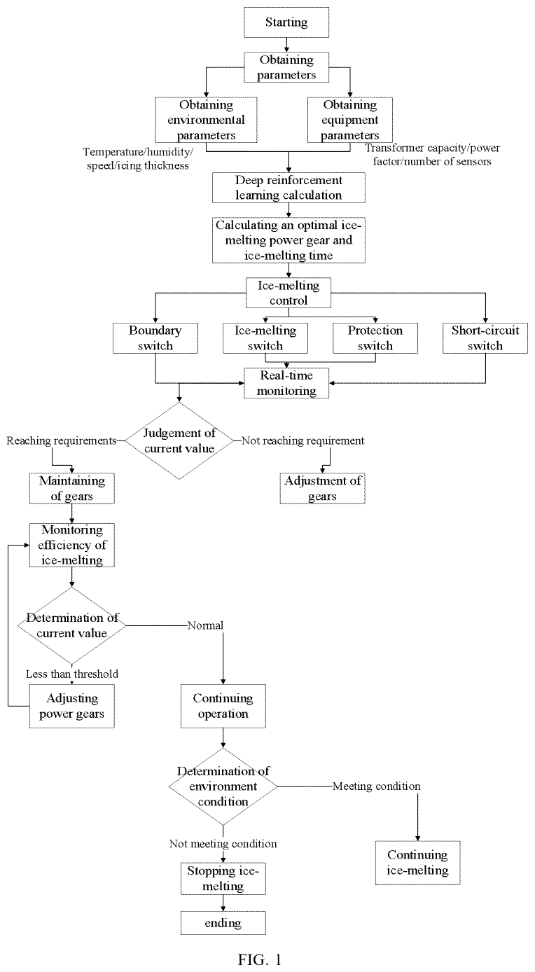

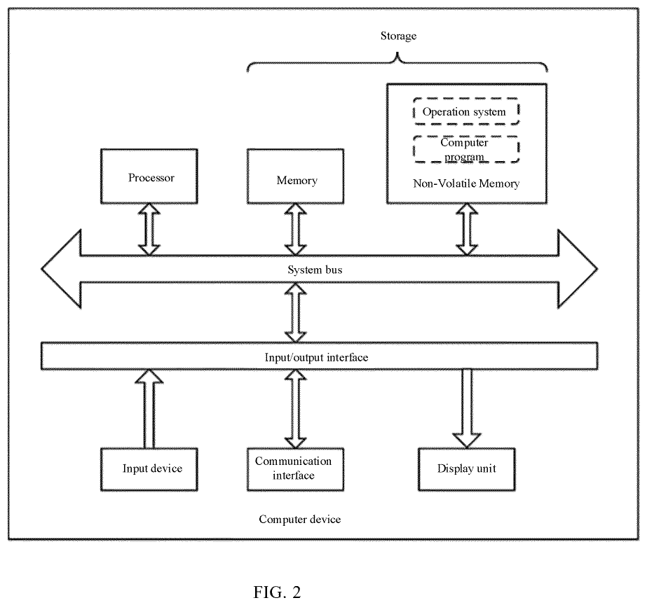

Embodiment 1, with reference to FIGS. 1 and 2, is the first embodiment of the present application. This embodiment provides an AC short-circuit ice-melting control method and an ice-melting distribution transformer, including:
S100: obtaining environmental parameters and equipment parameters of the ice-melting line. The environmental parameters include temperature, humidity, a wind speed, and an ice thickness; the equipment parameters include a rated capacity of the ice-melting transformer, power factor, and the number of temperature sensors.

In the embodiment of the present application, the environmental parameters are obtained by a multi-source data collection method. The temperature is measured by a PT100 temperature sensor with a measurement range of −50° C. to 150° C. and an accuracy of ±0.1° C. The humidity is measured by a capacitive humidity sensor with a measurement range of 0% to 100% RH and an accuracy of ±2% RH. The wind speed is measured by an ultrasonic wind speed sensor with a measurement range of 0 to 60 m/s and an accuracy of ±0.1 m/s. The ice thickness is measured by a laser ranging sensor with a measurement range of 0 to 500 mm and an accuracy of ±1 mm.

In an optional embodiment, the installation positions of the temperature sensors can be divided into three categories: line temperature sensors, ambient temperature sensors, and transformer temperature sensors. The line temperature sensor is installed on the surface of the conductor to directly monitor the conductor temperature. The ambient temperature sensor is installed on the tower, 2 meters above the ground, to monitor the ambient temperature. The transformer temperature sensor is installed on the transformer body to monitor the operating temperature of the transformer.

Specifically, the acquisition of equipment parameters is mainly realized through the distribution automation system. The rated capacity of the ice-melting transformer is read from the nameplate information, usually 100 kVA, 200 kVA, or 400 kVA. The power factor is measured in real-time by a power quality analyzer, generally not less than 0.95. The number of temperature sensors is determined according to the actual installation data, and each monitoring point is equipped with at least one temperature sensor.

It should be noted that both environmental parameters and equipment parameters are collected in real-time, with a sampling period of one minute. All parameter data are preprocessed by the on-site controller and then uploaded to the cloud data center in real-time through the 4G communication network. The system performs real-time verification on the collected data, and when abnormal data is found, the data compensation mechanism is started automatically to ensure the continuity and reliability of the data.

In the embodiment of the present application, the on-site controller adopts the STM32F407 processor with a main frequency of 168 MHz, built-in 512 KB Flash and 192 KB RAM. The controller is equipped with a 7-inch touch screen display interface, with an IP65 protection level, and an operating temperature range of −40° C. to 85° C.

The controller has the following functional modules:
Data acquisition module: Responsible for collecting environmental parameters and equipment parameters, supporting analog and digital input.
Data processing module: Preprocessing the collected data, including filtering, verification, and abnormality judgment.
Communication module: Supporting RS485, Ethernet, and 4G communication to realize remote data transmission.
Storage module: Using a 32 GB industrial-grade SD card, which can store 3 months of historical data.
Human-machine interface module: Providing parameter display, alarm prompts, and manual control functions.
S200: Based on the environmental parameters and the equipment parameters, using a deep reinforcement learning model to calculate an optimal ice-melting power gear and ice-melting time.
S201: Using the deep reinforcement learning model for adaptive control of ice-melting power includes: discretizing the ice-melting power into three actions: fast, medium, and slow; predicting a change of the ice thickness according to environmental parameters; calculating a line ice load and a risk of pole collapse; controlling the ice-melting power based on a balance of risk and cost.

In the embodiment of the present application, the deep reinforcement learning model is implemented using the Deep Deterministic Policy Gradient (DDPG) algorithm. The algorithm includes two parts: an actor network and a critic network. The actor network is responsible for selecting actions according to the state, that is, determining the optimal ice-melting power gear according to environmental parameters and the equipment parameters; the critic network is responsible for evaluating the value of the action, that is, evaluating the rationality of the selected power gear.

Specifically, the actor network adopts a three-layer fully connected network structure. The number of nodes in the input layer is the same dimension as the state, including parameters such as the temperature, the humidity, the wind speed, and the ice thickness. The hidden layer adopts a two-layer structure with 256 nodes in each layer, and the activation function is ReLU. The number of nodes in the output layer is 3, corresponding to the three optimal ice-melting power gears of fast, medium, and slow, and the activation function is tan h.

The critic network also adopts a three-layer fully connected structure. The input layer contains state and action information. The hidden layer adopts a two-layer structure with 256 nodes in each layer, and the activation function is ReLU. The output layer is a single node representing a Q value. The network training uses the Adam optimizer with learning rates of 1e-4 for the actor and 1e-3 for the critic.

In an optional embodiment, to improve the exploration efficiency of the model, an exploration strategy based on visibility is introduced. When the visibility is low, the exploration probability is increased, making the model tend to try different optimal ice-melting power gears. When the visibility is good, the exploration probability is reduced, and the learned experience is more used. The calculation formula of the exploration probability F is:

$$ε = 0.1 + 0.5 \times ( \frac{1 - visibility}{100} ) ;$$

where visibility is a current visibility with an unit in hectometers This dynamically adjusted exploration strategy significantly improves the model's adaptability under complex weather conditions.

It should be noted that the design of the model's reward function considers multiple aspects:

Ice elimination effect: Positive rewards are given according to the degree of reduction in ice thickness; Energy consumption: Negative rewards are given according to the power consumption during the ice-melting process; Time consumption: Negative rewards are given according to the duration of ice melting; Safety constraints: A large negative reward is given when there is a safety risk such as overheating.
S300: based on the optimal ice-melting power gear and the ice-melting time, controlling an output voltage and a switch sequence of the ice-melting transformer, where the switch sequence comprises action sequences of a boundary switch, an ice-melting switch, a protection switch, and a short-circuit switch.
S301: a control of the switch sequence comprises:
before a start of ice-melting operation, isolating non-ice-melting areas through the boundary switch;
based on a preset program, controlling a start and adjustment of ice-melting current through the ice-melting switch;
real-time monitoring a line status through the protection switch, and cutting off a power supply when an abnormality is detected; and
controlling a short-circuit of an end line through the short-circuit switch to form an ice-melting loop.

In the embodiment of the present application, the control of the ice-melting transformer adopts a hierarchical control architecture. The upper layer is power gear control, which is responsible for determining the target power gear according to the output result of the deep reinforcement learning model. The middle layer is voltage control, which is responsible for converting the power gear into a specific voltage setting value. The lower layer is switch control, which is responsible for executing the specific switch action sequence.

Specifically, the power gear control includes three gears: fast, medium, and slow:
Fast gear: corresponding to 90% to 100% of the rated power, suitable for severe icing conditions;
Medium gear: corresponding to 60% to 80% of the rated power, suitable for moderate icing conditions;
Slow gear: corresponding to 30% to 50% of the rated power, suitable for slight icing conditions.

In an optional embodiment, the voltage control adopts a fuzzy PID control strategy. The input of controller is the deviation e between the target power and the actual power and the deviation change rate ec, and the output of controller is the voltage adjustment amount. The control rules are as follows:
When |e| is large, increasing the proportional gain of the controller to speed up the response;
When |e| is small, reducing the proportional gain to improve control accuracy;
When |ec| is large, increasing the derivative time to suppress overshoot;
When |ec∥ is small, increasing the integral time to eliminate steady-state errors.

It should be noted that the switch control adopts a state machine design, including the following states:

Initial state: All switches are in the off state; Preparation state: the status signals of each switch are checked; Isolation state: the boundary switch acts to isolate the non-ice-melting area; Ice-melting state: the ice-melting switch and short-circuit switch act in sequence; Protection state: the protection switch acts when an abnormality occurs; Reset state: each switch resets after ice melting is completed; End state: the entire action sequence is completed.

In the embodiment of the present application, the switch action sequence control is implemented using the real-time operating system FreeRTOS, which has the following characteristics:
Priority management: the protection switch task has the highest priority to ensure system safety; task synchronization: a semaphore mechanism is used to ensure the accurate sequence of switch actions; real-time guarantee: the response time of key tasks does not exceed 10 ms; fault handling: task abnormalities can be detected and handled in a timely manner.
S400: real-time monitoring a current value during an ice-melting process; when the current value reaches a preset ice-melting current demand value, maintaining a current voltage gear; and when the current value does not reach the preset ice-melting current demand value, adjusting the current voltage gear until a requirement is met.
S401: further including: calculating and monitoring an ice-melting efficiency, where the ice-melting efficiency is a ratio of an actual ice-melting power to a maximum ice-melting power;
when the ice-melting efficiency is lower than a preset threshold, adjusting the optimal ice-melting power gear.
S402: further including a remote control: establishing a communication link between a local intelligent control box and a remote short-circuit communication control box; and realize remote monitoring, fault diagnosis, and emergency response.
S403: during the ice-melting process, when the ambient temperature is higher than a preset temperature threshold or the ice thickness is less than the preset thickness threshold, automatically stopping the ice-melting process, and recording the ice-melting time and power data.

In the embodiment of the present application, the current is monitored by a high-precision smart electricity meter, which has the following technical characteristics: sampling frequency: 4800 Hz; measurement accuracy: 0.2 class; range: 0 to 400 A; communication mode: Modbus-RTU; data refresh rate: 100 ms.

Specifically, the judgment logic of the current value includes three thresholds: a minimum threshold Iₘᵢₙ, which a value lower than indicates insufficient current; a target threshold I_{target} which is the desired current value; a maximum threshold Iₘₐₓ, which a value higher than requires voltage reduction protection.

It should be noted that the voltage gear is adjusted with a progressive control strategy:
When the actual current I<Iₘᵢₙ: if the current gear is not the highest, increasing by one gear; if it is already the highest gear, triggering an alarm; the interval between gear increases is not less than 30 seconds.
When Iₘᵢₙ≤I<I_{target}: Fine-tuning the voltage value of the current gear; the adjustment step is 1% of the rated value; the adjustment interval is 10 seconds.
When I_{target}≤I≤Iₘₐₓ: Maintaining the current gear unchanged; continuously monitoring current fluctuations; recording stable operation data.
When I>Iₘₐₓ: Immediately reducing by one gear; triggering an overcurrent protection alarm; recording overcurrent event information.

Further, this embodiment also provides an ice-melting distribution transformer, including:
a transformer body, configured with two groups of low-voltage output terminals, wherein a first group is a normal voltage output terminal designed for power distribution users, and a second group is a specific voltage output terminal designed for ice-melting operations;
an ice-melting control box, comprising a local intelligent control box and a remote short-circuit communication control box, where the local intelligent control box is provided with a one-key ice-melting button;
an ice-melting power regulating device, provided with multiple gears of ice-melting power output at an ice-melting output terminal;
a switch control system, comprising the boundary switch, the ice-melting switch, the protection switch, and the short-circuit switch.

The second group of specific voltage output terminals has multiple optimal ice-melting power gears for adjusting the output voltage according to an actual ice-covered distance and conductor types.

A deep reinforcement learning model operation unit is provided inside the local intelligent control box for calculating the multiple optimal ice-melting power gears and ice-melting time.

The remote short-circuit communication control box is connected to the local intelligent control box through a high-speed communication link to realize remote synchronous control.

In summary, the present application realizes the perfect combination of power supply and ice-melting functions through the structural design of dual output terminals of the distribution transformer, solves the problem that traditional schemes require a special ice-melting transformer or temporary modification, and achieves the effect of dual use of one machine and saving investment.

By introducing an ice-melting control strategy based on deep reinforcement learning, the system can independently learn the optimal ice-melting power gear and ice-melting time, thereby overcoming the defect that traditional fixed strategies cannot adapt to complex climatic conditions, and realizing the intelligent and precise control of the ice-melting process, and significantly improving the ice-melting efficiency.

By designing a multi-level optimal ice-melting power gear adjustment mechanism and combining with real-time calculation of the temperature rise sensitivity coefficient, the system can flexibly adjust the power output according to the actual icing situation, thereby avoiding the problems of energy waste or insufficient ice-melting caused by rough power adjustment in traditional schemes, and achieving the effects of refined control, energy conservation and environmental protection.

By integrating the coordinated control strategy of the boundary switch, ice-melting switch, protection switch and short-circuit switch, the system realizes the fully automatic operation of the ice-melting process, thereby eliminating the potential safety hazards caused by traditional manual operations, significantly improving the operation efficiency, and achieving safe, reliable, efficient and convenient ice-melting operations.

By establishing a two-way real-time communication mechanism between the local intelligent control box and the remote communication control box, the system is equipped with remote monitoring, fault diagnosis and emergency handling capabilities, thereby overcoming the problem of insufficient remote management capabilities in traditional schemes, realizing intelligent operation and maintenance and rapid response.

By designing a mechanism for real-time monitoring and automatic adjustment of ice-melting efficiency, the system can dynamically optimize ice-melting parameters, ensuring ice-melting quality while avoiding energy waste, and realizing the unity of economy and efficiency in the ice-melting process.

The present application not only solves the problems of low efficiency, poor safety and insufficient intelligence in traditional ice-melting schemes, but also significantly shortens the ice-melting time, greatly improves operational safety, and significantly enhances system reliability and adaptability.

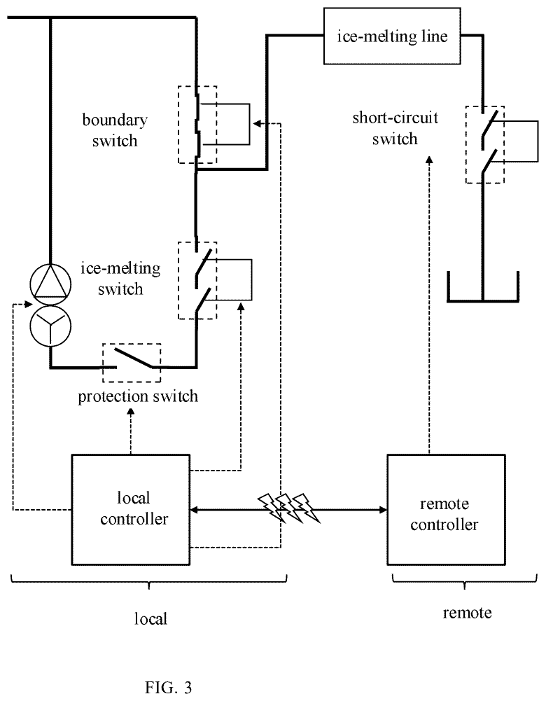

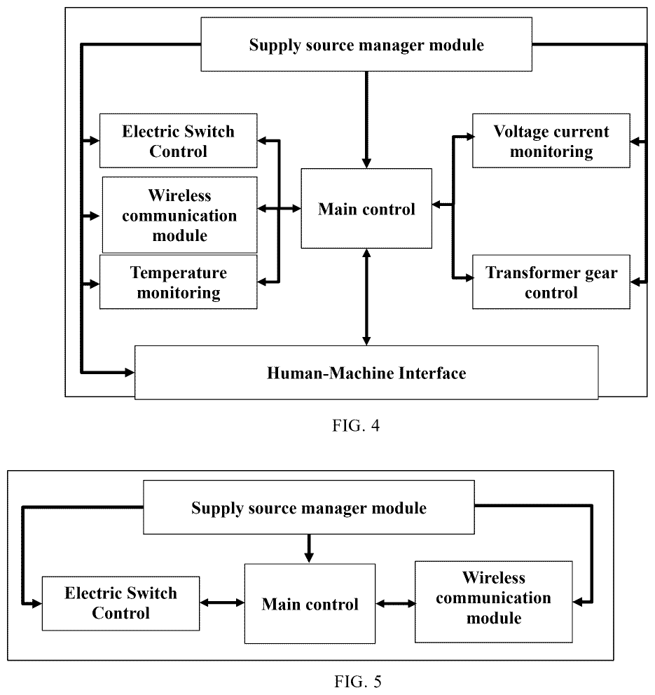

Embodiment 2, with reference to FIGS. 3 to 5, is the second embodiment of the present application, which provides an AC short-circuit ice-melting control method and an ice-melting distribution transformer.

It includes a multi-functional distribution transformer with dual functions of voltage reduction and ice melting, an ice-melting control box and an operation interface, a refined ice-melting power adjustment, and an ice-melting control method. The multi-functional distribution transformer is configured with two groups of low-voltage output terminals, the first group is specially designed for power distribution users, and the second group is specially designed for ice-melting operations. The ice-melting control box includes a local intelligent control box and a remote short-circuit communication control box. The ice-melting power adjustment is refined, multiple gears of ice-melting power output are provided at the ice-melting output terminal of the multi-functional distribution transformer. The ice-melting control method integrates the precise control sequence of the boundary switch, the ice-melting switch, the protection switch and the short-circuit switch.

Preferably, it includes a multi-functional distribution transformer with dual functions of voltage reduction and ice melting, an ice-melting control box and an operation interface, a refined ice-melting power adjustment, and an ice-melting control method.

Preferably, the multi-functional distribution transformer is configured with two groups of low-voltage output terminals. The first group is specially designed for power distribution users, providing standard normal voltage output to ensure daily electricity demand is met. The second group is specially designed for ice-melting operations, outputting a specific voltage to adapt to the special requirements for current and power during the ice-melting process.

Preferably, the ice-melting control box includes a local intelligent control box and a remote short-circuit communication control box. The local intelligent control box has built-in advanced control logic and is equipped with an intuitive and easy-to-use operation panel, which is specially provided with a one-key ice-melting button. The remote short-circuit communication control box realizes remote synchronization and control with the local control box through a high-speed and stable communication link, facilitating rapid response in emergency situations or remote monitoring and maintenance.

Preferably, the theoretical algorithm steps are as follows:
Step 1: Setting the state evaluation period T; obtaining equipment parameters of the ice-melting transformer and ice-melting line, where the equipment parameters include: a rated capacity S of the operating ice-melting transformer, a power factor cos θ of the ice-melting transformer, a number N_{TS} of temperature sensors of the ice-melting line, and an ice-melting temperature boundary Tᵤₚ of the ice-melting line;
Step 2: obtaining the real-time moment t;
Step 3: obtaining real-time operation data of each ice-melting transformer, where the real-time operation data includes: an operating active power Pₜ of the ice-melting transformer at time t, and a measured temperature T_{j,t} of the j-th temperature sensor of the ice-melting line at time t, where j∈1~N_{TS};
Step 4: obtaining historical operation data of the ice-melting transformer, where the historical operation data includes: an active power P_{7,t}, P_{2,t}, P_{1,t}, of the ice-melting transformer of each of the past seven operating days at time t, and a measured temperature T_{7,j,t}, T_{2,j,t}, T_{1,j,t} of the j-th temperature sensor of the ice-melting line of each of the past seven operating days at time t.
Step 5: Calculating the temperature rise sensitivity coefficient of each temperature sensor position of the ice-melting line under different load scenarios; the temperature rise sensitivity coefficient is used to reflect the relationship between the load of the ice-melting transformer and the temperature rise of the ice-melting line. This coefficient is used in Step 6 to calculate the ice-melting current demand, that is, by calculating the temperature that the iced line needs to rise to achieve ice melting, the temperature is combined with this coefficient to further obtain the load power that the ice-melting transformer needs to reach, and finally the ice-melting current demand value is obtained.
Step 5: Calculating the temperature rise sensitivity coefficient of each ice-melting transformer group under different load scenarios, which refers to the following steps:
(5-1) Calculating a load rate of each of the past seven operating days at time t according to the operating active power P_{7,t}, P_{2,t}, P_{1,t} of the ice-melting transformer of each of the past seven operating days at time t:

$${η}_{7 , t} = \frac{{P}_{7 , t}}{S cos θ}$$

$$…$$

$${η}_{1 , t} = \frac{{P}_{1 , t}}{S cos θ} ;$$

Where η_{7,t} is the load rate at time t of the 7th operating day; η_{1,t} is the load rate at time t of the 1st operating day; P_{7,t} is the operating active power at time t of the 7th operating day; P_{1,t} is the operating active power at time t of the 1st operating day; S is the rated capacity of the ice-melting transformer; cos θ is the power factor of the ice-melting transformer.
(5-2) Dividing the load rate scenarios into six gradients: [0.20%], (20%,40%], (40%,60%], (60%,80%], (80%,100%], and 100%, and labeling each calculated load rate that meets the corresponding scenario. For example, if the load rate of a certain ice-melting transformer at a certain time is 37.2%, then the ice-melting transformer is in the (20%,40%] scenario at that time.

Classifying the distribution sets F0-20, F20-40, F40-60, F60-80, F80-100, F>100 of all time points in the past seven operating days in the six load scenarios, and counting the number of time points K0-20, K20-40, K40-60, K60-80, K80-100, K>100 in each distribution set;
(5-3) Calculating the operating active power fluctuation value ΔP_{i,t} of the ice-melting transformer and the temperature fluctuation value ΔT_{j,t} measured by each temperature sensor of the ice-melting line for each of the past seven operating days at time t as:

$$Δ {P}_{7 , t} = {P}_{7 , t} - {P}_{7 , t - 1}$$

$$…$$

$$Δ {P}_{1 , t} = {P}_{1 , t} - {P}_{1 , t - 1}$$

$$Δ {T}_{7 , j , t} = {T}_{7 , j , t} - {T}_{7 , j , t - 1}$$

$$…$$

$$Δ {T}_{1 , j , t} = {T}_{1 , j , t} - {T}_{1 , j , t - 1} ;$$

Where ΔP_{1,t} is the operating active power fluctuation value at time t of the 1st operating day; P_{1,t} is the operating active power at time t of the 1st operating day; P_{1,t-1} is the operating active power at time t−1 of the 1st operating day.
ΔP_{7,t} is the operating active power fluctuation value at time t of the 7th operating day; P_{7,t} is the operating active power at time t of the 7th operating day; P_{7,t-1} is the operating active power at time t−1 of the 7th operating day.
ΔT_{1,j,t} is the temperature fluctuation value measured by the temperature sensor at time t of the 1st operating day of the ice-melting line; T_{1,j,t} is the temperature measured by the temperature sensor at time t of the 1st operating day; T_{1,i,t-1} is the temperature measured by the temperature sensor at time t−1 of the 1st operating day.
ΔT_{7,j,t} is the temperature fluctuation value measured by the temperature sensor at time t of the 7th operating day of the ice-melting line; T_{7,j,t} is the temperature measured by the temperature sensor at time t of the 7th operating day; T_{7,j,t-1} is the temperature measured by the temperature sensor at time t−1 of the 7th operating day.
(5-4) Calculating the temperature rise sensitivity coefficient of the j-th temperature sensor of the ice-melting line under different load scenarios as:

$${δ}_{0 - 20 , j} = \frac{1}{{K}_{0 - 20}} {\sum }_{t ∈ {D}_{0 - 20}} {{\sum }_{k = 1}}^{7} \frac{Δ {T}_{k , j , t}}{Δ {P}_{k , t}}$$

$$…$$

$${δ}_{> 100 , j} = \frac{1}{{K}_{> 100}} {\sum }_{t ∈ {D}_{> 100}} {{\sum }_{k = 1}}^{7} \frac{Δ {T}_{k , j , t}}{Δ {P}_{k , t}} ;$$

Where δ_{0-20,j} is the temperature rise sensitivity coefficient of the j-th temperature sensor of the ice-melting line under the [0.20%] load scenario; K₀₋₂₀ is the number of time points in the [0.20%] range within seven operating days; t∈D₀₋₂₀ is the time point with a load rate of 0-20%; k is the line number; ΔT_{k,j,t} is the temperature fluctuation; ΔP_{k,t} is the active power fluctuation.
δ_{>100,j} is the temperature rise sensitivity coefficient of the j-th temperature sensor of the ice-melting line under the >100% load scenario; K_{>100} is the number of time points exceeding 100% within seven operating days; t∈D_{>100} is the time point with a load rate greater than 100%; k is the line number; ΔT_{k,j,t} is the temperature fluctuation; ΔP_{k,t} is the active power fluctuation.
Step 6: Judging the operating temperature state of the ice-melting line at the next moment and establishing an ice-melting current demand calculation model based on the load-temperature rise test of the ice-melting line.
Step 6: Judging the operating temperature state of the ice-melting line at the next moment and establishing an ice-melting current demand calculation model based on the ice-melting line load-temperature rise test refers to the following steps:
(6-1) Predicting the temperature of the ice-melting line at the next moment according to the temperatures of the ice-melting line at the previous moment and the current moment:

$${T}_{j , t + 1} = {T}_{j , t} ( 1 + \frac{{T}_{j , t} - {T}_{j , t - 1}}{{T}_{j , t - 1}} ) ;$$

where T_{j,t+1} is the temperature of the j-th monitoring point at the next moment; T_{j,t} is the temperature of the j-th monitoring point at time t; T_{j,t-1} is the temperature of the j-th monitoring point at the previous moment.
(6-2) Within j∈{1, 2, 3, . . . , N_{i,TS}}, calculating the ice-melting temperature rise demand T_{j,t+1,need}:

$${T}_{j , t + 1 , need} = {T}_{j , t + 1} - {T}_{up} ;$$

If T_{j,t+1,need}>0, the line needs ice melting, and the line temperature needs to be increased by adjusting the voltage of the ice-melting transformer; if T_{j,t+1,need}≤0, no ice melting is required.
(6-3) Calculating the ice-melting current demand by combining the current load rate and the temperature rise factor of the transformer:

$${I}_{t + 1 , j , need} = \frac{{T}_{j , t + 1 , need}}{{U}_{N} {δ}_{j}} ;$$

$${I}_{t + 1 , need} = max \{ {I}_{t + 1 , 1 , need} , {I}_{t + 1 , 2 , , need} , … , {I}_{t + 1 , j , need} , … \} ;$$

Where I_{t+1,need} is the current required for ice melting at line position j; I_{t+1,need} is the ice-melting current to be output by the ice-melting transformer; U_{N} is the precise voltage value of the ice-melting transformer; δⱼ is the temperature rise sensitivity coefficient corresponding to the current load rate scenario selected based on the current load rate ηₜ of the ice-melting transformer.
(6-4) Adjusting the voltage gear according to the current output current value of the ice-melting transformer. If the current value of the ice-melting transformer Iₜ<I_{t+1,need}, adjusting the voltage gear upward, and controlling the boundary switch, the ice-melting switch, the protection switch, and the short-circuit switch. After adjustment, judging again whether the current value meets the ice-melting current demand until the voltage gear is adjusted to make the current value meet the ice-melting current demand.
Step 7: Waiting for ΔT duration and returning to Step 2.

Preferably, the ice-melting power adjustment is refined, multiple gears of ice-melting power output are provided at the ice-melting output terminal of the multi-functional distribution transformer, operators are allowed to flexibly select the appropriate power gear according to the actual icing situation, line characteristics, and environmental factors.

Preferably, the ice-melting control method integrates the precise control sequence of the boundary switch, the ice-melting switch, the protection switch, and the short-circuit switch; the boundary switch automatically isolates non-ice-melting areas before the start of ice-melting operations to protect other parts of the power grid from impact. The ice-melting switch precisely controls the start and adjustment of the ice-melting current according to a preset program to ensure a stable ice-melting process. The protection switch monitors the line status in real-time and can immediately cut off the power supply once an abnormality (such as overload, short circuit, etc.) is detected to protect equipment and personnel safety. The short-circuit switch controls the short circuit of the end line to form an ice-melting loop.

Preferably, the design formula for voltage transformation:

$${V}_{out} = \frac{{N}_{out}}{{N}_{in}} \times {V}_{in} ;$$

where Vₒᵤₜ is the voltage of the output terminal (normal voltage for power distribution users or voltage for ice melting); Nₒᵤₜ is the number of turns of the coil of the output terminal; Nᵢₙ is the number of turns of the coil of the input terminal; Vᵢₙ is the voltage of the input terminal.

Preferably, for the refined ice-melting power adjustment, multiple gears of ice-melting power output are provided at the ice-melting output terminal of the multi-functional distribution transformer, and the ice-melting power output is calculated by the following formula:

$${P}_{ice - melting} = {V}_{ice - melting} \times {I}_{ice - melting} ;$$

where P_{ice-melting} is the ice-melting power of the specific voltage output terminal; V_{ice-melting} is a voltage of the specific voltage output terminal used for ice-melting; I_{ice-melting} is a current during ice-melting.

Preferably, the ice-melting efficiency formula is set for the ice-melting process:

$${η}_{ice - melting} = \frac{{P}_{actual ice - melting}}{{P}_{maximum ice - melting}} ;$$

where η_{ice-melting} is an ice-melting efficiency; P_{actual ice-melting} is an actually used ice-melting power; P_{maximum ice-melting} is an ice-melting power of the transformer at a highest gear.

Preferably, time parameters are controlled during the ice-melting process, and the action times of the boundary switch, the ice-melting switch, the protection switch, and the short-circuit switch are controlled:

T_{total ice-melting}=T_{boundary}+T_{ice-melting}+T_{protection}+T_{short-circuit}+T_{process}
where T_{total ice-melting} is the total ice-melting time; T_{boundary} is the action time of the boundary switch; T_{ice-melting} is the action time of the ice-melting switch; T_{protection} is the action time of the protection switch; T_{short-circuit} is the action time of the short-circuit switch; T_{process} is the duration of the ice-melting process.

Preferably, adaptive control of ice-melting power based on a deep reinforcement learning model is adopted to solve the problem of difficult ice-melting decision-making caused by the variability of various parameters and weak perception in ice-melting strategies. In the deep reinforcement learning model, input parameters include the ambient temperature, the humidity, the wind speed, the ice thickness, the rated line load, etc., and the action strategy is affected by the predicted ice thickness. The action set consists of different ice-melting powers, which can be discretized into 3 actions (fast, medium, slow), and the ice-melting action will change the value of D_{new}.
(1) Calculating the predicted value of ice thickness:

$${D}_{new} = d + {k}_{1} \times ( {T}_{ref} - T ) \times \frac{( RH - {RH}_{ref} )}{100} \times v \times t ;$$

where D_{new} is a predicted new ice thickness (mm); d is a current ice thickness (mm); k₁ is the ice thickness coefficient (usually 0.01 to 0.05 mm/(° C.·%·m/s·h)); T_{ref} is the reference temperature (usually 0° C.); T is the ambient temperature (° C.); RH is the ambient relative humidity (%); RH_{ref} is the reference humidity (usually 85%); v is the wind speed (m/s); t is the time (h).

(2) Calculating the line ice load:

$$F = 9.82 \times {10}^{- 8} \times ρ \times π \times [ {( D + 2 {D}_{new} )}^{2} - {D}^{2} ] \times L ;$$

where ρ is the density of ice (900 kg/m³); D is the diameter of the transmission line (mm); D_{new} is the ice thickness (mm); L is the length of the transmission line between adjacent towers (m).
(3) Calculating the risk of pole collapse:

$$P = \frac{F}{{F}_{m}} ;$$

where F is the ice load; Fm is the rated ice load.

Calculating the ice-melting cost:

$$C = {f}_{( pow )} \times {D}_{new} ;$$

where C is the ice-melting cost; f_{(pow)} is the function of the relationship between power and cost; D_{new} is the ice thickness (mm); the cost functions for the 3 actions (fast, medium, slow) can be set based on experience.

Designing the reward function:

$${R}_{reward} = - {λ}_{1} \times P - {λ}_{2} \times C ;$$

where R_{reward} is used to balance the impact of risk and cost; λ₁ and λ₂ are weight coefficients; P is the risk of pole collapse; C is the ice-melting cost.

Based on the above calculations, network training can be completed using the DQN network, and the optimal balance between ice-melting power, risk, and cost can be found according to actual operation data.

Embodiment 3, with reference to FIGS. 3 to 5, is the third embodiment of the present application, which provides an AC short-circuit ice-melting control method and an ice-melting distribution transformer. To verify the beneficial effects of the present application, scientific demonstration is conducted through economic benefit calculation and simulation experiments.

The specific implementation of the present application will be further described below with reference to the accompanying drawings and examples.

Equipment parameters of the ice-melting transformer and ice-melting line are obtained: the rated capacity S of the ice-melting transformer is 100 kVA; the power factor cos θ is 0.95; the number N_{TS} of temperature sensors on the ice-melting line is 1; the ice-melting temperature boundary Tᵤₚ of the ice-melting line is 110° C.;

Real-time operation data of the ice-melting transformer is obtained, including the active power P_{i,t} of the operating ice-melting transformer at time t, and the measured temperature T_{j,t} of each operating turbine temperature sensor at time t.

Real-time operation data of each ice-melting transformer, including the operating active power Pₜ of the ice-melting transformer at time t; the measured temperature T_{j,t} of the j-th temperature sensor of the ice-melting line at time t, where j∈1~N_{TS}.

Historical operation data of the ice-melting transformer is obtained, including the active power P_{7,t}, P_{2,t}, P_{1,t} of the ice-melting transformer at time t of each of the past seven operating days, and the measured temperature T_{7,j,t}, T_{2,j,t}, T_{1,j,t} of the j-th temperature sensor of the ice-melting line at time t of each of the past seven operating days.

TABLE 1
Historical Active Power Data

| Time | | | | | | | | | |
|---|---|---|---|---|---|---|---|---|---|
| point | 1 | 2 | 3 | 4 | 5 | . . . | 94 | 95 | 96 |
| first day | 18.04 | 28.54 | 30.54 | 33.55 | 28.84 | . . . | 24.45 | 30.24 | 27.07 |
| . . . | . . . | . . . | . . . | . . . | . . . | . . . | . . . | . . . | . . . |
| seventh | 16.80 | 28.16 | 28.73 | 31.72 | 29.33 | . . . | 27.38 | 32.12 | 26.05 |
| day | | | | | | | | | |

TABLE 2
Historical Load Rate Data

| Time | | | | | | | | | |
|---|---|---|---|---|---|---|---|---|---|
| point | 1 | 2 | 3 | 4 | 5 | . . . | 94 | 95 | 96 |
| first day | 18.0% | 28.5% | 30.5% | 33.5% | 28.8% | . . . | 24.4% | 30.2% | 27.1% |
| . . . | . . . | . . . | . . . | . . . | . . . | . . . | . . . | . . . | . . . |
| seventh | 16.8% | 28.2% | 28.7% | 31.7% | 29.3% | . . . | 27.4% | 32.1% | 26.0% |
| day | | | | | | | | | |

TABLE 3
Historical Measured Temperature Data

| Time | | | | | | | | | |
|---|---|---|---|---|---|---|---|---|---|
| point | 1 | 2 | 3 | 4 | 5 | . . . | 94 | 95 | 96 |
| first day | 96.30 | 96.11 | 96.44 | 95.82 | 90.13 | . . . | 96.33 | 96.40 | 97.32 |
| . . . | . . . | . . . | . . . | . . . | . . . | . . . | . . . | . . . | . . . |
| seventh | 94.67 | 90.46 | 95.06 | 97.89 | 90.67 | . . . | 95.55 | 95.94 | 95.81 |
| day | | | | | | | | | |

The distribution sets F0-20, F20-40, F40-60, F60-80, F80-100, F>100 of all time points in the past seven operating days in the six load scenarios are classified, and the number of time points in each distribution set is count as K0-20=216, K20-40=195, K40-60=152, K60-80=82, K80-100=27, K>100=0.

The active power fluctuation values ΔPₜ of the ice-melting transformer and the temperature fluctuation values measured by the temperature sensor at time t of each of the past seven operating days are calculated. Some data are shown in Tables 4 and 5 below.

TABLE 4
Active Power Fluctuation Data

| Time | | | | | | | | | |
|---|---|---|---|---|---|---|---|---|---|
| point | 2 | 3 | 4 | 5 | 6 | . . . | 94 | 95 | 96 |
| first day | 10.50 | 2.01 | 3.01 | −4.70 | −3.48 | . . . | 1.46 | 5.79 | −3.17 |
| . . . | . . . | . . . | . . . | . . . | . . . | . . . | . . . | . . . | . . . |
| seventh | 11.36 | 0.57 | 2.99 | −2.38 | −4.48 | . . . | 1.46 | 5.79 | −3.17 |
| day | | | | | | | | | |

TABLE 5
Measured Temperature Fluctuation Data

| Time | | | | | | | | | |
|---|---|---|---|---|---|---|---|---|---|
| point | 2 | 3 | 4 | 5 | 6 | . . . | 94 | 95 | 96 |
| first day | −0.19 | 0.33 | −0.62 | −5.68 | 4.39 | . . . | 1.80 | 0.07 | 0.92 |
| . . . | . . . | . . . | . . . | . . . | . . . | . . . | . . . | . . . | . . . |
| seventh | −4.21 | 4.61 | 2.83 | −7.22 | 7.19 | . . . | 1.23 | 0.39 | −0.13 |
| day | | | | | | | | | |

The temperature rise sensitivity coefficients δ_{0-20,j}, δ_{20-40,j}, δ_{40-60,j}, δ_{60-80,j}, δ_{80-100,j} of the j-th temperature sensor under different load scenarios are calculated as: 1.745, 1.417, 1.243, 0.869, 0.694.

The real-time measured active power of the ice-melting transformer at a certain time is 86.7 kW, the temperature of the ice-melting line is 6.7° C., the current ice thickness is 12 mm, the ice thickness coefficient is 0.01, the reference temperature is 0° C., the ambient temperature is 6.7° C., the ambient relative humidity is 82%, the reference humidity is 85%, the wind speed is 2 m/s, the ice density is 900 kg/m³, the transmission line diameter is 95 mm, the length of the transmission line between adjacent towers is 2 km, weight coefficients of the risk and cost are 0.5 and 0.5 respectively, the active power generated at the previous moment is 80.3 kW, and the predicted temperature of the ice-melting line at the next moment is −3.1° C. There is a risk of icing and a need for ice melting. The load rate gradient will be in the 80%~100% gradient, and the temperature rise coefficient of 0.694 is selected. The calculated ice-melting current demand value is 218.7 A. The voltage gear is adjusted upward, and the boundary switch, the ice-melting switch, the protection switch, and the short-circuit switch are controlled at the same time. After on-site adjustment, the ice-melting current reaches 218.7 A.

It should be noted that the above embodiments are only used to illustrate the technical solution of the present application and not to limit it. Although the present application has been described in detail with reference to the preferred embodiments, those of ordinary skill in the art should understand that the technical solution of the present application can be modified or equivalently replaced without departing from the spirit and scope of the technical solution of the present application, which should be covered in the claims of the present application.

What is claimed is:

1. An alternative current (AC) short-circuit ice-melting control method, comprising:
obtaining environmental parameters and equipment parameters of an ice-melting line, where the environmental parameters comprise temperature, humidity, a wind speed, and an ice thickness, and the equipment parameters comprise a rated capacity and a power factor of an ice-melting transformer, and a number of temperature sensors;
based on the environmental parameters and the equipment parameters, using a deep reinforcement learning model to calculate an optimal ice-melting power gear and ice-melting time;
based on the optimal ice-melting power gear and the ice-melting time, controlling an output voltage and a switch sequence of the ice-melting transformer, where the switch sequence comprises action sequences of a boundary switch, an ice-melting switch, a protection switch, and a short-circuit switch;
calculating a temperature rise sensitivity coefficient, which is obtained based on a division of load rate scenarios and a calculation of temperature fluctuation of the ice-melting transformer in seven operating days;
wherein operation data of the ice-melting transformer in seven operating days is divided into six load rate scenarios according to [0.20%], (20%,40%], (40%,60%], (60%,80%], (80%,100%], and 100%, and the temperature rise sensitivity coefficient under each scenario is calculated based on a relationship between a power fluctuation value and a temperature fluctuation value;
based on the temperature rise sensitivity coefficient, real-time monitoring a current value during an ice-melting process;
when the current value reaches a preset ice-melting current demand value, maintaining a current voltage gear; and
when the current value does not reach the preset ice-melting current demand value, adjusting the current voltage gear until a requirement is met.

2. The AC short-circuit ice-melting control method according to claim 1, wherein using the deep reinforcement learning model for adaptive control of ice-melting power comprises:
discretizing the ice-melting power into three actions: fast, medium, and slow;
predicting a change of the ice thickness according to environmental parameters;
calculating a line ice load and a risk of pole collapse;
controlling the ice-melting power based on a balance of risk and cost;
where the balance of risk and cost uses a reward function for ice-melting power control, and the reward function for the balance of risk and cost needs to adopt a coefficient value of ice-melting cost;
wherein a prediction of the ice thickness change uses a following formula:
$${D}_{new} = d + {k}_{1} \times ( {T}_{ref} - T ) \times \frac{( RH - {RH}_{ref} )}{100} \times v \times t ;$$
wherein, D_{new} is a predicted new ice thickness; d is a current ice thickness; k1 is an ice thickness coefficient; T_{ref} is a reference temperature; RH is an ambient temperature; T is an ambient relative humidity; RH_{ref} is a reference humidity; v is a wind speed; t is the time;
wherein the line ice load is calculated using a following formula:
$$F = 9.82 \times {10}^{- 8} \times ρ \times π \times [ {( D + 2 {D}_{new} )}^{2} - {D}^{2} ] \times L ;$$
wherein, ρ is a density of ice; D is a diameter of a transmission line; D_{new} is the ice thickness; L is a length of the transmission line between adjacent towers;
wherein a risk P of pole collapse is calculated using a following formula:
$$P = \frac{F}{{F}_{m}} ;$$
wherein F is an ice load; Fₘ is a rated ice load;
wherein the ice-melting cost C is calculated using a following formula:
$$C = {f}_{( pow )} \times {D}_{new} ;$$
wherein C is the ice-melting cost, f_{(pow)} is a function of a relationship between power and cost, and D_{new} is the ice thickness;
wherein the reward function R_{reward} for the balance of risk and cost uses a following formula:
$${R}_{reward} = - {λ}_{1} \times P - {λ}_{2} \times C ;$$
wherein R_{reward} is used to balance an impact of risk and cost, λ₁ and λ₂ are weight coefficients, P is the risk of pole collapse, and C is the ice-melting cost.

3. The AC short-circuit ice-melting control method according to claim 2, wherein a control of the switch sequence comprises:
before a start of ice-melting operation, isolating non-ice-melting areas through the boundary switch;
based on a preset program, controlling a start and adjustment of ice-melting current through the ice-melting switch;
real-time monitoring a line status through the protection switch, and cutting off a power supply when an abnormality is detected; and
controlling a short-circuit of an end line through the short-circuit switch to form an ice-melting loop.

4. The AC short-circuit ice-melting control method according to claim 3, further comprising:
calculating and monitoring an ice-melting efficiency, wherein the ice-melting efficiency is a ratio of an actual ice-melting power to a maximum ice-melting power;
when the ice-melting efficiency is lower than a preset threshold, adjusting the optimal ice-melting power gear.

5. The AC short-circuit ice-melting control method according to claim 4, further comprising: a remote control:
establishing a communication link between a local intelligent control box and a remote short-circuit communication control box; and
realize remote monitoring, fault diagnosis, and emergency response.

6. The AC short-circuit ice-melting control method according to claim 5, wherein during the ice-melting process, when the ambient temperature is higher than a preset temperature threshold or the ice thickness is less than the preset thickness threshold, automatically stopping the ice-melting process, and recording the ice-melting time and power data.

7. An ice-melting distribution transformer, based on the AC short-circuit ice-melting control method according to claim 1, comprising:
a transformer body, configured with two groups of low-voltage output terminals, wherein a first group is a normal voltage output terminal designed for power distribution users, and a second group is a specific voltage output terminal designed for ice-melting operations;
wherein the two groups of low-voltage output terminals have two states: one is working alone, and another is carrying out ice-melting and supplying power to low-voltage users at the same time;
wherein output voltages of the two groups of low-voltage output terminals satisfy:
$${V}_{out} = \frac{{N}_{out}}{{N}_{in}} \times {V}_{in} ;$$
wherein Vₒᵤₜ is an voltage of the low-voltage output terminal; Nₒᵤₜ is a number of turns of a coil of the low-voltage output terminal; Nᵢₙ is a number of turns of a coil of an input terminal; Vᵢₙ is a voltage of the input terminal;
wherein an ice-melting power of the specific voltage output terminal designed for ice-melting operations satisfies:
$${P}_{ice - melting} = {V}_{ice - melting} \times {I}_{ice - melting} ;$$
wherein P_{ice-melting} is the ice-melting power of the specific voltage output terminal; V_{ice-melting} is a voltage of the specific voltage output terminal used for ice-melting; I_{ice-melting} is a current during ice-melting;
an ice-melting control box, comprising a local intelligent control box and a remote short-circuit communication control box, where the local intelligent control box is provided with a one-key ice-melting button;
an ice-melting power regulating device, provided with multiple gears of ice-melting power output at an ice-melting output terminal;
wherein an efficiency of the ice-melting power output satisfies:
$${η}_{ice - melting} = \frac{{P}_{actual ice - melting}}{{P}_{maximum ice - melting}} ;$$
wherein η_{ice-melting} is an ice-melting efficiency; P_{actual ice-melting} is an actually used ice-melting power; P_{maximum ice-melting} is an ice-melting power of the transformer at a highest gear; and
a switch control system, comprising the boundary switch, the ice-melting switch, the protection switch, and the short-circuit switch.

8. The ice-melting distribution transformer according to claim 7, wherein the second group of specific voltage output terminals has multiple optimal ice-melting power gears for adjusting the output voltage according to an actual ice-covered distance and conductor types.

9. The ice-melting distribution transformer according to claim 8, wherein a deep reinforcement learning model operation unit is provided inside the local intelligent control box for calculating the multiple optimal ice-melting power gears and ice-melting time.

10. The ice-melting distribution transformer according to claim 9, wherein the remote short-circuit communication control box is connected to the local intelligent control box through a high-speed communication link to realize remote synchronous control.
